(19) United States
(12) Patent Application Publication
(10) Pub. No.: US 2006/0203076 A1
(43) Pub. Date: Sep. 14, 2006

(54) Method and apparatus for analyzing an imaging material to enable adjustment to the development of the imaging material

(76) Inventors: Graham F. Nelson, Saint Paul, MN (US); Brian L. Johnson, Maple Grove, MN (US)

Correspondence Address: Pamela R. Crocker;Patent Legal Staff, Eastman Kodak Company, 343 State Street, Rochester, NY, 14650-2201, US

(21) Appl. No.: 11/076,806

(22) Filed: Mar. 10, 2005

(51) Int. Cl. B41J 2/00

(52) U.S. Cl. 347/188

(57) ABSTRACT

A method and apparatus for analyzing a test image on an imaging material and using that analysis to adjust a device(s) and/or method for developing a main, i.e., desired, image on an imaging material. The apparatus and method can be useful for so-called digital or analog imaging materials.

### FIELD OF THE INVENTION

The present invention relates to an apparatus and method for analyzing an imaging material and using that analysis to adjust a device(s) and/or a method step(s) for developing an imaging material.

### BACKGROUND OF THE INVENTION

One form of imaging material is a radiation sensitive film that includes a thin polymeric base coated, generally on one side, with an imageable composition. Such compositions include silver halide and dry silver compositions.

One type of radiation sensitive film is exposed with a laser beam that is scanned to create a pattern based on stored or incoming digital data. This “digital” film can be exposed by the laser beam based on data, in essence, captured by medical imaging modalities such as MRI, CT, and other image capture devices. An example of this type of film used in medical imaging applications is DryView™ film available from the Eastman Kodak Company. The quality of the image from sheet to sheet of film depends on the spot size, wavelength, and intensity of the beam when exposing the film as well as the temperature and dwell time when processing or developing the film. DryView film is exposed and processed using one of a number of DryView imagers. This device includes a sensitometric system that enables the device to apply a test image to a sheet of film, read the test image, and correspondingly adjust the exposure for a sheet of film. Though this approach can improve the image quality, it consumes an entire sheet of film and has been applied only to digital film.

Another type of radiation sensitive medical imaging film, referred to as “analog” film. Analog imaging systems significantly predate the digital imaging systems. An analog film is exposed not by a laser based on stored image data like digital film, but by radiation created by, for example, a phosphor screen positioned adjacent the analog film. That is, the phosphor screen and the medical analog film are within a cassette that is placed next to a patient to receive x-ray radiation from an x-ray source that passes through a region of the patient's body. When the x-ray strikes the phosphor screen, the screen responds by emitting an electromagnetic radiation having a wavelength to which the film is sensitive. The emitted radiation, in turn, strikes and exposes the analog film. Following this exposure, the image on the film is processed or developed. One type of analog film is processed using solutions (aka wet processing), one commercial embodiment of which is Kodak Healthcare's Ektascan films. Another type of analog film is processed using heat like the above-described digital film (aka dry processing), one embodiment of which is described in U.S. patent application Ser. No. 10/715,199. With either analog film type, the processing can affect image quality.

There is a need for an film, apparatus, and method for evaluating and adjusting the processing of the so-called analog medical imaging film. They would preferably not require knowing the type, lot, age, past storage conditions, or other aspects of the imaging media being used. There is also a need for an approach for evaluating and adjusting the processing of a film that avoids the above-noted expense associated with the consumption of an entire sheet of film which, in effect, may encourage more frequent evaluations to improve the ultimate image displayed by the processed film.

### SUMMARY OF THE INVENTION

In one embodiment, the present invention provides a method for controlling the development of a segregate area of imaging material. The method can include applying a test image onto a first portion of a segregate area of imaging material. It can further include analyzing a characteristic of the test image. Still further, the method can include developing a desired image on a second portion of the segregate area of imaging material based on the analyzed characteristic of the test image.

In another embodiment, the present invention provides an imaging apparatus having a first imaging device for applying a test image to a segregate area of imaging material. A densitometer determines the density of the at least one portion of the test image. A second device develops a desired image on the segregate area of imaging material based on the determined image density of the test image.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a flowchart illustrating one embodiment of a method of the present invention.

FIG. 2 is a perspective view of one embodiment of an apparatus of the present invention.

FIG. 3 is a side schematic view of the embodiment similar shown in FIG. 2.

FIG. 4 is a side view of an exposure portion of the embodiment shown in FIGS. 2 and 3.

FIGS. 5 and 5A-A are a front view and a side sectional view thereof, respectively, of a heating portion of the embodiment shown in FIGS. 2 and 3.

FIG. 6 is a view of a density test patch usable in conjunction with the present invention.

FIG. 7 is a flowchart illustrating another embodiment of a method of the present invention.

### DETAILED DESCRIPTION OF THE INVENTION

The invention is described in detail herein with particular reference to certain preferred embodiments thereof, but it will be understood that variations, modifications, other combinations of aspects of embodiments can be effected within the spirit and scope of the invention.

The present invention is useful in conjunction with various imaging materials and processing equipment and methodologies. As one example, the present invention is suitable for “analog” imaging material, such as medical x-ray film, that is thermally developed. In addition to medical x-ray film, the present invention is also suitable for industrial x-ray film applications as are other x-ray film applications.

As another example, the present invention is suitable for “digital” imaging material, such as DryView™ film, that is thermally developed. As still another example, the present invention is suitable for “digital” material that is imaged not with a two-step approach, then develop approach, but with a single thermal imaging step. Still other imaging materials may benefit by the present invention.

Typically, each of these types imaging materials are used in individual sheets, like a stack of copy paper. These materials can instead by used in roll form and can subsequently be sheeted as desired. That is, the present invention can be used with a segregate area of imaging material, such as a discrete sheet of imaging material, a segment cut or to be cut from a longer roll or other bulk form, or the like.

One embodiment of the present invention that is useful for an analog imaging material is a method for controlling the development of an imaging material. One step is to apply a test image onto a segregate area of imaging material. Other steps are to analyze a characteristic of the test image and to develop a desired image on the segregate area of imaging material based on the analyzed characteristic of the test image. The desired image could be an image of a portion of a human patient captured using an x-ray device (or another animal in a veterinary application). That desired image can be exposed onto the segregate area of imaging material prior to the step of applying the test image onto the imaging material.

The patient image can be exposed with a known x-ray approach that involves placing an x-ray cassette (not shown) adjacent a portion of a patient's body and opposite to an x-ray radiation source such that x-ray radiation from the source passes through the body to the cassette. The cassette will typically contain the sheet of medical imaging material (e.g., x-ray film) and a sheet of x-ray sensitive, radiation-emitting material adjacent the segregate area of imaging material. The x-ray sensitive, radiation-emitting material in a cassette is often referred to as a phosphor screen because phosphor in this material, when struck by x-ray radiation, emits the particular wavelength radiation that strikes the sensitive medical imaging material (e.g., the x-ray analog film). As a result of this construction, when x-ray radiation is directed into a human body and absorbed by the body to a greater or lesser degree (depending on the type of body tissue), the portion of the x-ray radiation that passes through the body and strikes the phosphor screen generates radiation that exposes the sheet of radiation-sensitive medical imaging. The exposed image can, for example, be of a broken bone.

X-ray cassettes, such as the one described above, can and often do include a window or shutter having a lead cover and located adjacent a relatively small portion of the film within the cassette. The window or shutter can be opened such that the lead cover does not prevent x-ray radiation from passing to the phosphor causing the phosphor to emit the radiation upon the film. That is, opening the shutter allows the x-ray technician to expose patient information onto the portion of the film adjacent the shutter. Closing the shutter prior to the diagnostic exposure prevents x-ray radiation from the diagnostic exposure from exposing the portion of film on which the patient information is exposed (or thereafter to be exposed). In conjunction with or as part of the present invention, this shutter (or another shutter) can be sized to such that in addition to shielding the portion of the film for the patient information, the shutter can shield a sufficient portion of the film for the test patch referring to in this disclosure. Or, rather than using a lead-included shutter to shield the portion of the film for the test patch, the cassette can simply include an non-moving piece of lead (or other x-ray opaque material) that is sized and positioned within or on the cassette to shield that portion of the film.

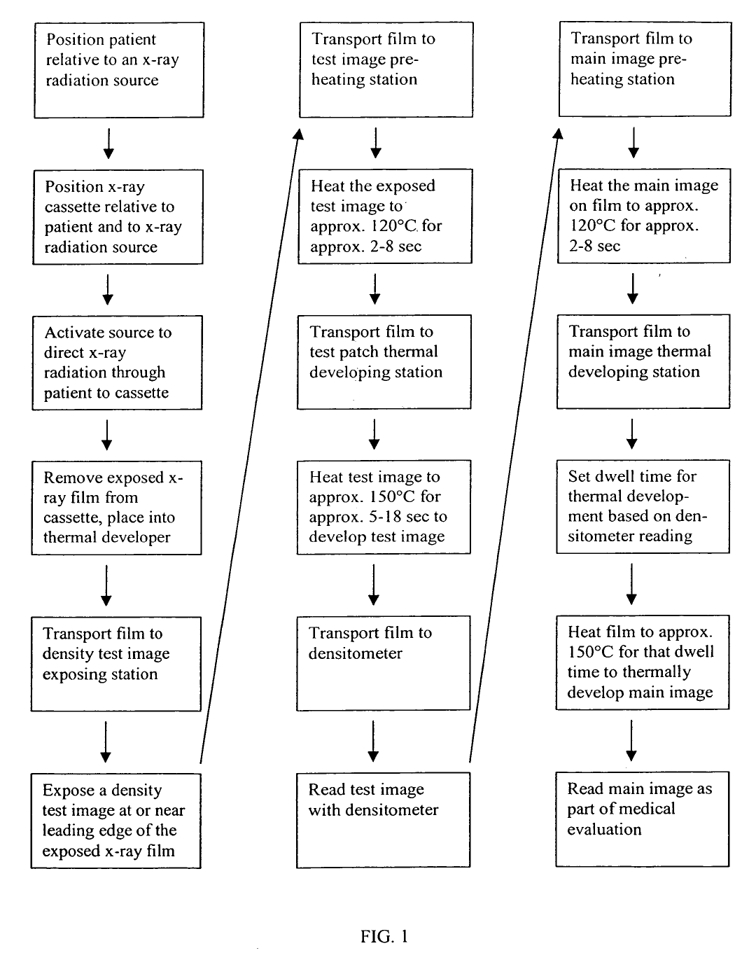

FIG. 1 is a flowchart that includes one group of steps that can be used in conjunction with an analog imaging material, such as an x-ray film. Variations of the method shown by the flowchart can include the elimination of some of the steps, the addition of other steps, variations on some of the steps, reordering of some of the steps, simultaneous occurrence of some of the steps. As one example, one or more of the transporting steps could be replaced by steps in which the exposing, heating, and/or reading components of the apparatus move to and from the film. As another example, the temperatures, dwell time, and exposure parameters can be different from those noted to suit the particular film or film type as well as the specific image. Still another example can be the inclusion of a cooling step between the thermal development and the densitometer reading steps.

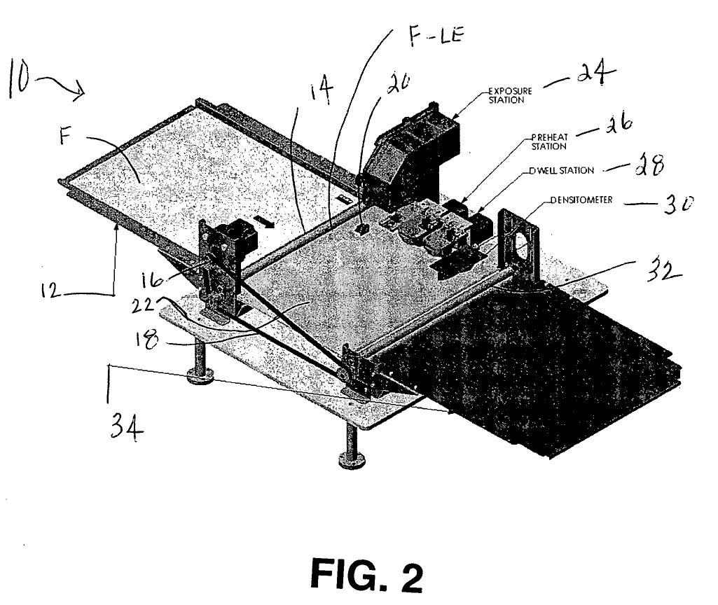

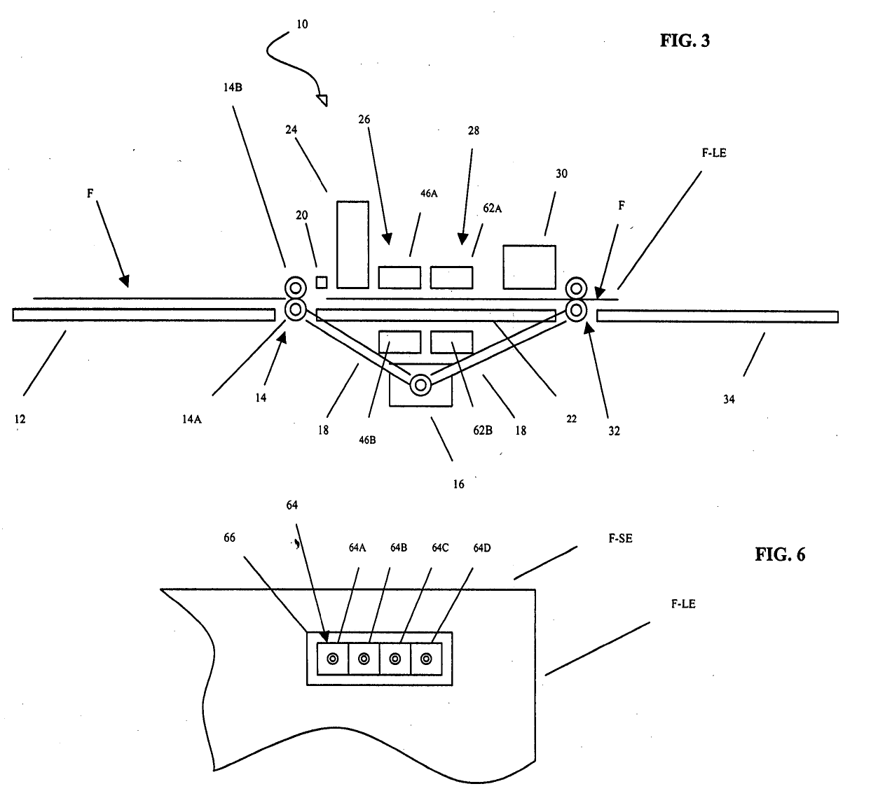

FIGS. 2 and 3 illustrate two similar embodiments of apparatus 10 that can carry out some of the above-noted steps in a fashion suitable for an analog film. Apparatus 10 can include an entrance tray 12 having a smooth surface, such as a stainless steel or hard polymeric platform or contain, on or in which one or more segregate areas or lengths of film F may be placed for insertion into the remainder of apparatus 10. A film drive means, such as a pair of entrance nip rollers 14 (e.g., 22 mm OD) driven by a stepper motor/gear box 16 (e.g., Vextra PK423A1A-SG18, 1.8 degree, 18:1 GR) and a drive belt 18 (e.g., 5.08 millimeter pitch timing belt). Preferably the lower roller 14A of the nip rollers 14 is driven by the belt 18. The nip rollers 14 can have about a 22 millimeter outer diameter. The upper roller 14B can be spring-loaded downwardly toward the lower roller 14A. Another film drive means could involve both the lower and upper rollers being driven. Still another film drive means could be a plurality of lower rollers on which the film F can ride. The drive belt 18 could be replaced with a gear connected to and driven by the stepper motor that mates with one or more gears connected to one or both of the nip rollers 14. The stepper motor could be replaced by another form of motor or by a manual driven crank or the like.

Apparatus 10 includes means for detecting the leading edge F-LE of the film F as the film F is transported to one or more positions within the apparatus 10. That detecting means may be an optical flag switch 20, e.g., OPTEK OPB696B, or a non-optic radiation switch, or a switch that physically contacts the leading edge F-LE of the film F.

A mid-tray 22 is adjacent the entrance tray 12 to receive the film F. Above the mid-tray 22, the apparatus 10 includes a test image exposure station 24, a test image conditioning station 26, a test image development or dwell station 28, and a densitometer 30, each of which are positioned along the film transport path. Each is described in more detail later herein.

A pair of exit nip rollers 32 provide another aspect of the drive means similar to the above-described entrance nip rollers 14. The exit nip rollers 32 are positioned adjacent the mid-tray 22 to transport the film 4 away from the mid tray 22 and onto an exit tray 34. The exit nip rollers 32 can be configured, driven, and spring-loaded like the entrance nip rollers 14. The exit tray 34, like the entrance and mid trays 12, 22, is preferably smooth, e.g., deburred and polished, in order to eliminate or minimize, or at least reduce the amount of scratching that could occur to the film F when sliding through the apparatus 10.

Though not shown, apparatus 10 can also include a second conditioning station and dwell station for conditioning and thermally developing the film F. These condition and dwell stations or other condition and dwell apparatus, such as those employed by DryView™ devices available from Eastman Kodak Company (Health Imaging), can be used in conjunction with apparatus 10.

Similarly, apparatus 10 can be configured such that the test image conditioning station 26 and a test image development or dwell station 28 are also capable of initially heating the main or desired image and further heating that image (to the point of thermal development) following the calibration using the test image. For example, after the test image is read by the densitometer, the film F could be transported back to the conditioning station 26 such that the entire sheet of film F would be initially heated, then heated to a point at which the film F is thermally developed by the development or dwell station 28. One way this could work is for the conditioning and thermal development stations to have the ability to process the entire film width and for the test patch to be exposed at or near the leading edge F-LE such that the conditioning and thermal development would only occur at that edge (leaving the remainder of the film F for the desired or main image).

Apparatus 10 can also include a computer, PLC, or another form of controller or data storage device that contains a look-up table of, for example, image density data and corresponding dwell time data. As such, apparatus 10 is capable of using the density data read by the densitometer to locate a desired dwell time for thermally developing the film F. For example, if the image density is determined to be about 1.4 optical density, the desired dwell time could be between about 20 and about 22 seconds (preferably about 21 seconds). Or, rather than to have a look-up table, apparatus 10 may contain an equation that calculates the desired dwell time for thermally developing the film based on the image density reading(s). Further, the density reading could be such that the system would indicate to the user that the film cannot produce an acceptable image regardless of the development variables.

The upstream exposing, conditioning, and thermal developing steps and components for the test image can be implemented in a number of ways to work in conjunction with the downstream conditioning and dwell stations for processing the desired image. For example, the test image steps and components can be made to function as similarly as possible to how the main image is exposed, conditioned, and thermally developed. Though this approach is straightforward, it has the disadvantage of approximately doubling the time to develop a film F. Another approach is to expose, condition, and/or thermally develop the test image in faster ways that do not adversely affect the apparatus' ability to develop the desired image as desired. As one example, the conditioning step and/or the thermal developing step for the test image may be carried out using a higher temperature, higher heat transfer rate material, and/or higher pressure to accomplish a shorter duration than that of the conditioning step and/or thermal developing step for the desired image, while still providing the correlation between the optical density of the test image and the development variables to create the desired film development.

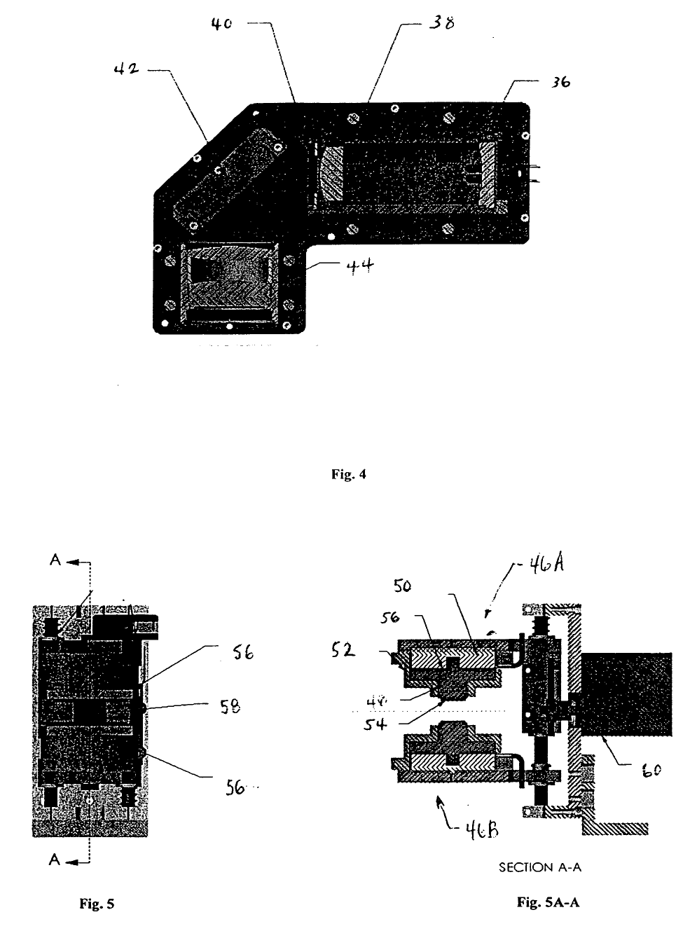

This paragraph and several of the following paragraphs describe in greater detail aspects of the first embodiment noted above regarding steps and means for exposing a test image, conditioning the test image, thermally developing the test image, reading the density of the test image, and exposing and/or developing the desired image based on the density of the test image. With respect to the test image exposure station 24, the film may be exposed by “flash” exposing a “latent” image of the test patch (preferably within +/− one percent variability). One approach for exposing the test image could include an LED source 36 (ETG-5UV395-30, 100 mw), a collimating lens 38, a lens array 40 (PROCA, 20×20), a fold mirror 42, and a condenser lens 44, as shown in FIG. 4. Another approach for exposing the test patch could be to use radiation emitted by an integrating sphere or another cavity device (not shown). Still another exposing approach could be to employ a laser. Still another approach is to flood light onto a mask having a desired test image pattern and that is positioned adjacent the portion of the film F where the test image is desired.

For the film described in U.S. patent application Ser. No. 10/715,199 (which is hereby incorporated by reference), the wavelength of the exposing radiation is approximately 395 nanometers. For a DryView™ film, the wavelength of the exposing radiation is approximately 810 nanometers. The wavelength can be altered according to the sensitivity of the imaging material being used.

The test image conditioning station 26 is intended to raise the temperature of the film F sufficiently to do one or more of the following: allow for the release of gas, such as water vapor, created by heating the film F (aka outgassing) that, if trapped, can adversely affect the image; control the physical expansion of the film F due to its temperature rise to avoid or reduce wrinkles or other image-distorting effects; heat the film F at a rate or to a particular temperature such that the thermal developing means can subsequently heat the film F at the same or a different rate; heat the film F to below the point at which thermal development occurs to prepare the film F for the subsequent thermal development step.

As shown in FIG. 5 (and FIG. 5A-A), the conditioning station 26 includes an opposing pair of first heated members 46A,B (46A being the first upper heated member; 46B being the first lower heated member). Each of the first heated members 46A,B includes a heat sink member 48 (aluminum), a foam insulation member 50 (medium density silicone sponge; 6-14 psi at 25% compression), mount insulation member 52 (Torlon 4203), a heat pad 54 (Dow Corning 8990 silicone, 0.030 inch thick), and a heater 56 (Minco thermofoil heater; 110 volt; 16 Watts of heat). The first heated members 48A,B can be moved toward, against, and away from the film F when the exposed test image is positioned below it using a rack and pinion 58 driven by a motor/gear box 60 (Vextra PK243A1A-SG18, 1.8 deg step with 18:1 ratio).

The test patch on a film (such as the film described in U.S. patent application Ser. No. 10/715,199) is conditioned by raising the temperature of the film F to, for example, about 110-130 degrees Celsius (preferably about 120 degrees Celsius) for between about two and about eight seconds (preferably about seven seconds). During the period in which the film is being heated, the first heated members 46A,B can be moved apart one or more times to allow any trapped gas, such as water vapor, to escape. Repeatedly moving the first heated members 46A,B into and out of contact with the film F is a way to mimic or approximate the heating of film F when transported through a flatbed of heated rollers for the purpose of conditioning the entire segregate area of the film F in preparation for developing the entire segregate area. That is, a flatbed of rollers, such as the flatbed processor described in pending U.S. patent application Ser. No. 10/815,027 (which is hereby incorporated by reference), causes both sides of the film to come into and out of contact with the rollers as the film F is being heated and traveling in a serpentine path between the rollers.

Rather than conditioning with conductive heat transfer using the first pair of heating members 46A,B, heat can be transferred to the test patch radiantly, convectively, or through a combination of two or three of these heating approaches. For example, a heat lamp (not shown) could be positioned to radiate heat onto the test patch. And, heat could be transferred to the film F from the bottom side rather than the top side as shown or from both the bottom and top sides.

As shown in FIGS. 2 and 3, the test image development or dwell station 28 can be generally the same and employed in the same way as the previously-described test image conditioning station 26 (or like the alternative conditioning approaches also noted above). For example, for the conductive heating approach, the test image development station 28 can include a pair of second heated members 62A,B that are moved toward and against the exposed and now conditioned test patch when the film F is advanced such that the test patch is directly below the second heated members 62A,B. The second heated members 62A,B can be moved using the same type of mechanics as those described above with respect to the first heated members 46A,B. The pre-developed test patch of a film (sometimes referred to as the latent image) is thermally developed by raising the temperature of the film F to about 140-160 degrees Celsius or more preferably at about 150 degrees Celsius for a dwell time of between about 18 and about 23 seconds, or more preferably between about 20 and about 21 seconds.

The densitometer 30 is an analytical tool or means for determining or measuring the optical density of the developed or final image at one or more portions of the test patch. (The test patch is described in more detail below.) Optical density is one characteristic of the image that may be used to guide the subsequent conditioning and thermal development of the main image on the film F. The density measured by the densitometer can be compared to a look-up table that lists density levels with corresponding dwell times for subsequently thermally developing the main image. That is, if the densitometer measures 1.4 optical density, the look-up table may include a density value closest to the measured value that corresponds with a dwell time of about 21 seconds. For greater accuracy, the test image, the densitometer, and look-up table can be configured such that multiple density readings are taken, one or more of which can be of different image densities. For example, as described in greater detail below, the test patch can have multiple portions or regions, each having a different density.

FIG. 6 shows one corner of film F. Near the corner of the film F is a test patch or image 64 that had been exposed onto the film F and developed. For example, the test patch 64 can be positioned between about zero millimeter and about 16 millimeters from each edge that makes up the corner. More specifically, it can be positioned about 25 millimeters from the side edge F-SE of the material 10 and about eight millimeters from the leading edge F-LE of the material 10. The test patch 12 is shown having four generally square portions 64A, 64B, 64C, 64D, though fewer or more portions can be used as desired. The first patch portion 64A can be exposed such that an acceptable development of that portion 64A would have a desired mid-range density D_{mid}. The second patch portion 64B can be exposed such that an acceptable development of that portion 64B would be the minimum density Dₘᵢₙ. The third patch portion 64C can be exposed such that an acceptable development of that portion 64C would be the maximum density Dₘₐₓ (or D_{dark}). The fourth patch portion 64D can be exposed such that an acceptable development of that portion 64D would be a density between the mid-range density D_{mid} and the minimum density Dₘᵢₙ.

The densitometer 30 can be configured to take a sample size of one or more (e.g., four) density readings from 2.5 millimeter diameter region in each of the four patch portions. The larger rectangle 66 surrounding the test patch 64 can be the portion or area of the material F that is conditioned, thermally developed, or both (so that the entire exposed area that makes up the test patch 64 is developed).

Apparatus 10 can alter parameters other than the dwell time during the thermal conditioning and/or thermal development of the main image based on the image density data from the test image. For example, apparatus 10 can set or adjust the temperature to which the film F is heated, the rate of heat transfer, and the pressure applied to the film (if any).

Using the above described inventive approach, a user need not know the exact type of imaging media, lot of media, the age of that media, the past storage conditions of the media, or a previous calibration result for that media. This is relevant because a given x-ray facility may use several film types, for example, films configured for different levels of x-ray exposure to suit different portions of the anatomy and/or different maladies. This is also relevant because one group of film may be used more quickly than another group of film, which can result a change of the image density of the more aged group of film.

Also, using the above-described approach, a complete sheet of film F need not be wasted. That is, image density can be controlled or affected with a test patch or image applied at or near an edge of the film such that the main image on that film is not overwritten, at least not substantially overwritten, and not otherwise adversely affected, at least not substantially adversely affected. However, the above described inventive approach can be used in conjunction with a complete sheet calibration step.

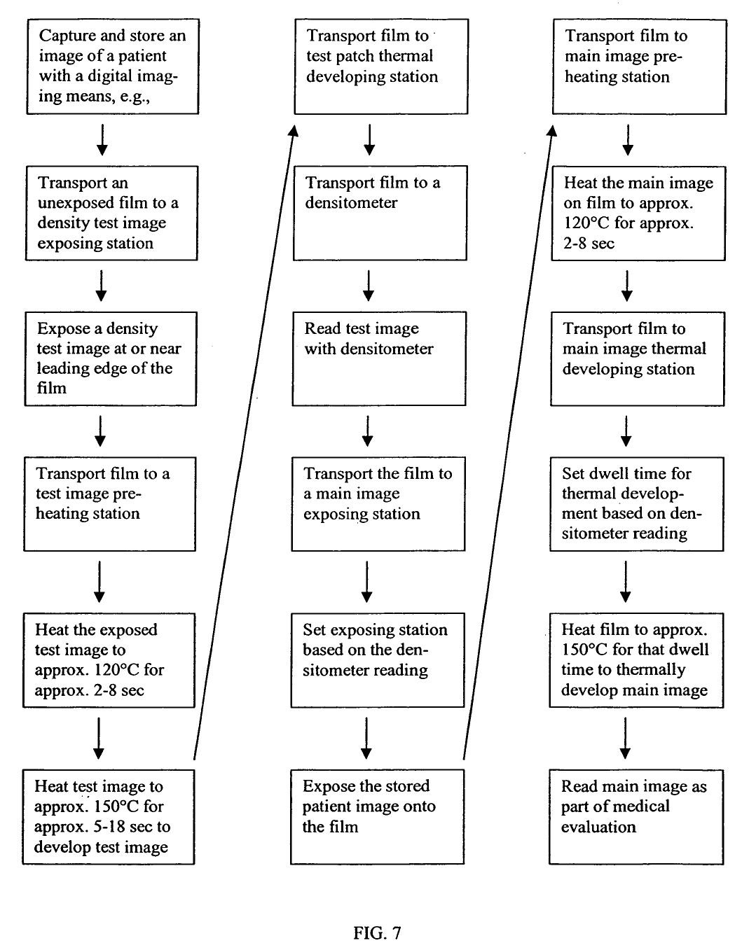

Another embodiment of the present invention is suitable for digital imaging application. This approach is similar to the approach(es) described above, but with the desired image (e.g., image of a portion of a human patient) being applied to the segregate area of imaging material after applying the test image. One group of steps for this embodiment is shown in the flowchart of FIG. 7. These steps work, for example, with a “photothermographic” digital film, like Kodak DryView™ film. That is, the steps include exposing an image onto the film with photons (i.e., the film is photon-sensitive) and developing the exposed image with heat (i.e., the exposed image in heat-sensitive).

Another embodiment of the present invention is suitable for a digital imaging application using a film that may be imaged with a single step rather than the above-described two-step approach (photon, then heat). One such film is configured such that the point application of heat completes the imaging. This type of film has been referred to as “thermographic.” The present invention can be used to apply a test image at or near an edge of a segregate area of film in order to better apply the desired image on the remainder of that film.

All documents, patents, journal articles and other materials cited in the present application are hereby incorporated by reference.

Although specific embodiments and applications have been illustrated and described herein, it will be appreciated by those of ordinary skill in the art that a variety of alternate and/or equivalent embodiments, applications, and implementations may be substituted without departing from the scope of the present invention. This application is intended to cover any adaptations, variations, combinations, and subsets of the specific embodiments discussed or illustrated herein. For example, several embodiments of the present invention are disclosed within the flowchart of FIGS. 1 and 7 in the form of smaller subsets of the shown steps. Therefore, it is intended that this invention be limited only by the claims and the equivalents thereof.

### Parts List

F film
F-LE leading edge of film F
F-SE side edge of film F
10 apparatus
12 entrance tray
14 nip rollers
14A lower nip roller
14B upper nip roller
16 stepper motor/gear box
18 drive belt
20 optical flag switch
22 mid tray
24 test image exposure station
26 test image conditioning station
28 test image development or dwell station
30 densitometer
32 exit nip rollers
34 exit tray
36 LED
38 collimating lens
40 lens array
42 fold mirror
44 condenser lens
46A,B first heated member (condition)
48 heat sink member
50 foam insulation member
52 mount insulation member
54 heat pad
56 heater
58 rack and pinion
60 motor/gear box 60
62A,B second heated member (develop)
64 test patch
64A test patch first portion
64B test patch second portion
64C test patch third portion
64D test patch fourth portion
66 condition/development area

What is claimed is:

1. A method for controlling the development of a segregate area of imaging material, comprising the steps of:
applying a test image onto a first portion of a segregate area of imaging material;
analyzing a characteristic of the test image; and
developing a desired image on a second portion of the segregate area of imaging material based on the analyzed characteristic of the test image.

2. The method of claim 1, wherein the desired image was exposed onto the segregate area of imaging material prior to the step of applying the test image onto the segregate area of imaging material.

3. The method of claim 2, further comprising the steps of:
exposing the desired image onto the segregate area of imaging material prior to the step of applying the test image; and
shielding the first portion of the segregate area of imaging material during the step of exposing the desired image.

4. The method of claim 3, wherein the step of exposing the desired image comprises placing a cassette adjacent a portion of a patient's body and opposite to an x-ray radiation source such that x-ray radiation passes through the patient's body to the cassette, wherein the cassette contains the segregate area of imaging material and a sheet of x-ray sensitive, radiation-emitting material adjacent the segregate area of imaging material.

5. The method of claim 4, wherein the segregate area of imaging material comprises at least one layer of a radiation-sensitive composition on at least one side of a polymeric film base, wherein the sheet of x-ray sensitive, radiation-emitting material comprises a phosphor screen, and wherein the cassette includes an x-ray opaque member that shields a portion of the phosphor screen adjacent the first portion of the segregate area of imaging material and prevents radiation emitted from the phosphor screen from exposing the first portion of the segregate area of imaging material.

6. The method of claim 1, further comprising the step of exposing the desired image onto the segregate area of imaging material after or at the same time as applying the test image.

7. The method of claim 1, wherein the desired image comprises an image of a portion of a human body.

8. The method of claim 1, wherein the step of applying the test image comprises the steps of:
exposing the test image onto the segregate area of imaging material; and
developing the test image.

9. The method of claim 8, wherein the step of exposing the test image comprises directing radiation onto the imaging material to form an exposed image made up of at least two image regions, each image region having a different exposure density.

10. The method of claim 8, wherein the step of exposing the test image is accomplished using at least one a lens array, an integrated sphere, a laser, and a test image mask.

11. The method of claim 8, wherein the step of exposing the test image onto the imaging material comprises exposing the test image at or near an edge of the imaging material.

12. The method of claim 11, further comprising the steps of:
transporting the imaging material to a location relative to an exposing device where the step of exposing the test image occurs, wherein the step of exposing the test image results in the test image being exposed at or near a leading edge of the transported segregate area of imaging material; and
transporting the imaging material to a location relative to a developing device where the step of developing the test image occurs.

13. The method of claim 8, further comprising the step of conditioning the portion of the imaging material on which the test image was exposed, wherein the conditioning step occurs before the step of developing the test image, wherein the step of developing the test image comprises heating the imaging material.

14. The method of claim 13, wherein the conditioning step raises the temperature of the portion of the segregate area of imaging material on which the test image is exposed to between about 10 degrees Celsius to about 130 degrees Celsius, and wherein developing step raises the temperature of the portion of the segregate area of imaging material on which the test image is exposed to between about 140 degrees Celsius to about 160 degrees Celsius.

15. The method of claim 13, wherein the step of conditioning the test image comprises heating the segregate area of imaging material primarily with conductive heating, and wherein the step of developing the test image comprises heating the segregate area of imaging material primarily with conductive heating.

16. The method of claim 15, wherein the step of conditioning the test image comprises moving a first pair of heated members into contact with the portion of the segregate area of imaging material on which the test image was exposed; and
wherein the step of developing the test image comprises moving a second pair of heated members into contact with the portion of the segregate area of imaging material on which the test image was exposed.

17. The method of claim 1, wherein the step of analyzing a characteristic of the test image comprises determining a value of a characteristic of the test image.

18. The method of claim 17, wherein the step of determining the value comprises determining the optical density of the test image in at least one region of the test image using a densitometer.

19. The method of claim 1, wherein the step of developing the desired image comprises causing the segregate area of imaging material to contact at least one heated member to heat the segregate area of imaging material for a dwell time selected from a look-up table, wherein the selection of the dwell time is based on the analysis of the characteristic of the test image.

20. An imaging apparatus, comprising:
a first imaging device for applying a test image to a segregate area of imaging material;
a densitometer for determining the density of the at least one portion of the test image; and
a second device for developing a desired image on the segregate area of imaging material based on the determined image density of the test image.

21. The apparatus of claim 20, wherein the first imaging device comprises:
a first exposing device for exposing the imaging material to radiation to create an initial form of the test image;
a first heating device for heating the test image on the segregate area of imaging material in preparation for thermal development of the test image; and
a second heating device for heating the test image to thermally develop the initial form of the test image of the conditioned segregate area of imaging material to a final form of the image.

22. The apparatus of claim 21, wherein the segregate area of imaging material is a radiation-sensitive x-ray film, wherein the first exposing device is configured to direct radiation at a radiation-sensitive x-ray film;
wherein the first heating device comprises a first heating member heated to between about 110 degrees Celsius and about 130 degrees Celsius; and
wherein the second heating device comprises a first heating member heated to between about 140 degrees Celsius and about 160 degrees Celsius.
